(19) United States
(12) Patent Application Publication
(10) Pub. No.: US 2024/0230234 A9
(43) Pub. Date: Jul. 11, 2024

(54) APPARATUS AND METHOD FOR PREVENTING LINING DISRUPTIONS EXPOSED TO ELEVATED TEMPERATURE

(71) Applicant: HarbisonWalker International Holdings, Inc., Moon Township, PA (US)

(72) Inventors: Corey Forster, Carnegie, PA (US); Benjamin Stanton, Pittsburgh, PA (US); Tom Williams, Gibsonia, PA (US)

(73) Assignee: HarbisonWalker International Holdings, Inc., Moon Township, PA (US)

(21) Appl. No.: 17/971,715

(22) Filed: Oct. 24, 2022

(51) Int. Cl. F27D 1/00; F27D 1/14

(52) U.S. Cl. CPC F27D 1/004; F27D 1/14

(57) ABSTRACT

A refractory unit for lining a high temperature vessel includes a refractory body formed from a refractory material. The refractory body has an upper main surface, a lower main surface, an inner surface configurable to face a high temperature chamber, an outer surface configurable to face away from the high temperature chamber, a first side surface and a second side surface. An elastic member is attached to the outer surface.

### FIELD OF THE INVENTION

The present invention relates generally to refractory linings, and more particularly, to a refractory unit and method for preventing disruptions in the refractory lining due to expansion and contraction.

### BACKGROUND OF THE INVENTION

Refractory-lined high temperature process vessels require careful consideration and design to account for thermal expansion of the refractory (an in particular the refractory units that define the refractory lining) when at operating temperatures. Pressure from the expansion of the individual refractory results in the development of compressive forces within the refractory lining as well as tensile forces in a steel shell of the process vessel, which restricts the refractory expansion. If the steel shell has not been designed to account for such tensile forces, pressure from the expansion of refractory can result in failure of the steel shell in the form of deformation, creep, splitting, broken welds, or other distortions. Further, if the refractory does not have enough compressive strength at the operating temperatures of the process vessel, pressure from the expansion of refractory lining can result in mechanical failure of the refractory in the form of spalling, cracking, or crushing.

Lining design usually calls for strong and dense layers of refractory, facing the inner of the process vessel, and placed in front of weaker, less dense, and more insulating layers of refractory, which are placed in front of the outside steel shell of the vessel. Increases in temperature within the process vessel from ambient conditions to operating temperatures result in increases in temperature to both the refractory and the steel shell. Steel, which expands at a greater rate with respect to temperature than the refractory, can relieve some of the pressure from the refractory growth.

Despite steel growing at a faster rate than refractory, generally, the temperatures that the steel reaches do not rise to the level that produces significant expansion of the steel shell and, as a result, there is more net growth in the refractory, exposed directly to elevated temperature within the process vessel, than the outside steel shell. Thus, an “expansion allowance” for the refractory is necessary.

Steel shell temperatures are dependent on the overall amount of insulation. A move towards a more thermally efficient lining can exacerbate the need for an expansion allowance. Although the heating and subsequent growth of the steel shell can relieve some stress from refractory growth, expansion allowances are designed based on steady state thermodynamics. The initial heat-up of the process vessel is based on transient thermodynamics, which means that the refractory will approach its steady state temperatures faster than the steel shell. Therefore, there is a further need for proper expansion allowance.

Creep in the refractory brick is another undesirable failure mode that can result in less or zero compression within the refractory lining, when the process vessel, after shutting down, is being inspected at ambient conditions. Alternatively, if a refractory lining, at high temperatures, generates enough pressure to crush insulating material behind it, the lining at ambient conditions will likely have no compression. As a result of limited or no compression, for example a horizontal cylindrical lining with zero compression may have a refractory brick slippage around the 12 o'clock position and the brick will re-wedge itself. As a result, the lining will effectively have a smaller circumferential measurement than it did before. Repeated cycles can cause damage to the backup linings, can result in an air pocket, or gap behind the hotface material around 12 o'clock position, which over time may cause lining disruptions and eventually to a collapse.

### SUMMARY OF THE INVENTION

Refractories are inherently inelastic. Very little force or pressure is absorbed and stored in elastic deformation of the material. Even the most compressible backup materials, such as Refractory Ceramic Fiber (RCF), have poor rebound or recovery. This is an indication that the material has yielded and will not return to its initial dimensions.

The present invention provides a refractory unit for constructing a refractory lining and a refractory lining design that provides an elastic lining that can move relative to the steel shell. Such movement prevents disruption of the refractory lining as components expand and contract at different rates due to temperature variations.

An advantage of the present invention is that, due to the elastic nature of the refractory, the destructive effects of thermal expansion and contraction seen in conventional refractories can be reduced or eliminated, thereby increasing the life of the refractory and extending the operational cycle of the process vessel.

According to one aspect of the invention, a refractory unit for lining a high temperature vessel includes: a refractory body formed from a refractory material and having an upper main surface, a lower main surface, an inner surface configurable to face a high temperature chamber, an outer surface configurable to face away from the high temperature chamber, a first side surface and a second side surface; and an elastic member attached to the outer surface.

In one example, the refractory unit includes a mount having a first surface and a second surface generally parallel to the first surface, the first surface fixedly attached to the outer surface, and the elastic member attached to the second surface.

In one example, the mount comprises at least one of a metal plate, a ceramic plate, or a composite plate.

In one example, the mount is molded into the refractory body.

In one example, the mount is attached to the refractory body using an adhesive.

In one example, the elastic member is welded to the mount.

In one example, the elastic member comprises a spring.

In one example, the elastic member comprises a leaf spring having a first end and a second end distal from the first end, the first end fixedly attached to the mount and the second end movable relative to the mount.

In one example, the elastic member comprises a plurality of elastic members arranged in a series or parallel configuration.

In one example, the spring comprises a metal spring.

In one example, the spring comprises an array of springs stacked one over the other.

In one example, the elastic member comprises at least one coned-disc spring.

In one example, the at least one coned-disc spring comprises a plurality of coned-disk springs arranged in a stacked configuration.

In one example, the refractory unit is a preformed refractory shape.

In one example, the preformed refractory shape is a refractory brick.

In one example, the chamber comprises at least one of a container or a conduit.

According to another aspect of the invention, a method for constructing a refractory lining for a high temperature vessel includes arranging a plurality of refractory units relative to each other, wherein at least some of the plurality of refractory units are elastically coupled to at least one of an adjacent refractory unit or a shell of the high temperature vessel.

In one example, each refractory unit comprises a refractory body formed from a refractory material and having an upper main surface, a lower main surface, an inner surface configurable to face a high temperature chamber, an outer surface configurable to face away from the high temperature chamber, a first side surface and a second side surface, and the method further includes arranging a thermal material between the shell and the outer surface of the refractory units.

In one example, the method includes using the chamber for at least one of metal-making, non-metal making, chemical-making, gas-making, heat-making, or high-temperature reaction.

In one example, arranging the thermal material includes using refractory ceramic fiber (RCF) felt as the thermal material.

In one example, the method includes using an elastic member attached to the plurality of refractory units to provide the elastic coupling.

In one example, the method includes filling voids between the elastic member and the at least one of the adjacent refractor unit or the steel shell.

In one example, filling voids includes using refractory ceramic fiber (RCF) pumpable material or RCF vacuum molding to fill the voids.

Examples of the specific embodiments are illustrated in the accompanying drawings. While the invention will be described in conjunction with these specific embodiments, it will be understood that it is not intended to limit the invention to such specific embodiments. On the contrary, it is intended to cover alternatives, modifications, and equivalents as may be included within the spirit and scope of the invention. In the following description, numerous specific details are set forth in order to provide a thorough understanding of the present invention. The present invention may be practiced without some or all of these specific details. In other instances, well-known process operations have not been described in details so as to not unnecessarily obscure the present invention.

These and other advantages will become apparent from the following description of a preferred embodiment taken together with the accompanying drawings and the appended claims.

### BRIEF DESCRIPTION OF THE DRAWINGS

The invention may take physical form in certain parts and arrangement of parts, a preferred embodiment of which will be described in detail in the specification and illustrated in the accompanying drawings which form a part hereof, and wherein:

FIG. 1 is a perspective view of an exemplary refractory unit in accordance with an embodiment of the invention;

FIG. 2A is a side view of an exemplary refractory unit illustrating attachment of a support structure to a refractory brick in accordance with an embodiment of the invention;

FIG. 2B is a side view of an exemplary refractory unit illustrating attachment of a support structure to a refractory brick in accordance with another embodiment of the invention;

FIG. 3A is a side view of an attachment means of an elastic member to a support structure in accordance with an embodiment of the invention;

FIG. 3B is a side view of an attachment means of an elastic member to a support structure in accordance with another embodiment of the invention;

FIG. 4A is a top view of an exemplary elastic member and support structure in accordance with an embodiment of the invention;

FIG. 4B is a top view of an exemplary elastic member and support structure in accordance with another embodiment of the invention;

FIG. 4C is a front view of the embodiments of FIGS. 4A and 4B;

FIG. 5A is a side view of an exemplary elastic unit and support structure in accordance with another embodiment of the invention;

FIG. 5B is a top view of the elastic unit and support structure of FIG. 5A;

FIG. 5C is a front view of the elastic unit and support structure of FIG. 5A;

FIG. 6A is a side view of an exemplary elastic unit and support structure in accordance with another embodiment of the invention; and

FIG. 6B is a perspective view of the elastic unit and support structure of FIG. 6A.

### DETAILED DESCRIPTION OF PREFERRED EMBODIMENT

Various aspects of the invention now will be described more fully hereinafter. Such aspects, however, may be embodied in many different forms and should not be construed as limited to the embodiments set forth herein; rather, these embodiments are provided so that this disclosure will be thorough and complete, and will fully convey its scope to those skilled in the art.

The word “about” when immediately preceding a numerical value means a range of plus or minus 10% of that value, e.g., “about 50” means 45 to 55, “about 25,000” means 22,500 to 27,500, etc., unless the context of the disclosure indicates otherwise, or is inconsistent with such an interpretation. For example, in a list of numerical values such as “about 49, about 50, about 55, “about 50” means a range extending to less than half the interval(s) between the preceding and subsequent values, e.g., more than 49.5 to less than 52.5. Furthermore, the phrases “less than about” a value or “greater than about” a value should be understood in view of the definition of the term “about” provided herein.

As used herein, the term “refractory material” refers to inorganic nonmetal materials utilized in various high-temperature equipment, e.g., steel production, other metal production, non-metal production, glass, cement, lime, chemical, gas, energy production and the like. Refractory materials are characterized by a high melting point, and when exposed to high temperatures they retain some of their strength and retain their form.

One aspect of the invention is directed to a method of constructing an elastic refractory lining that can account for expansion during heating and contraction during cooling. The elastic nature of the refractory lining, which can be used for metal-making, non-metal making, chemical-making, gas-making, heat-making, a high-temperature reaction, or any other high-temperature process, enables movement of at least some parts of the refractory lining relative to other parts of the refractory lining and/or to the steel shell. Such movement prevents disruption of the refractory lining as components expand and contract at different rates due to temperature variations.

In accordance with the method of constructing a refractory lining, a plurality of refractory units are arranged relative to each other, wherein at least some of the plurality of refractory units are elastically coupled to at least one of an adjacent refractory unit or a steel shell of a high-temperature vessel. The elastic coupling enables movement of the refractory units due to expansion and contraction during temperature cycling. Additionally, a thermal material, such as refractory ceramic fiber (RCF) felt, can be arranged between the steel shell and an outer surface of the refractory units to thermally insulate individual layers from adjacent layers. Further, RCF pumpable material or RCF vacuum molding can be used to fill voids between an elastic member of the refractory units and the at least one of an adjacent refractory unit or the steel shell. These thermal materials help to seal the liner area yet enable movement of the individual refractory units. Anchoring or tieback systems also may be utilized, where the anchoring/tieback systems are configured to provide degrees of freedom (, i.e., the ability to move in certain directions without breaking at a weld point).

Another aspect of the invention is directed to a refractory unit that includes an elastic member attached to one face of the refractory unit. To attach the elastic member to the refractory unit, a mount (also referred to as a support member), such as a metal plate or the like, may be secured to the refractory unit, and the elastic member may be secured to the mount. The mount can be attached to a cold face or bed joint of the refractory unit, although depending on pressing orientation, the plate may be on the head joint (or a surface perpendicular to the hotface of the lining). The elastic member enables the refractory unit to move for expansion during heating and contraction during cooling.

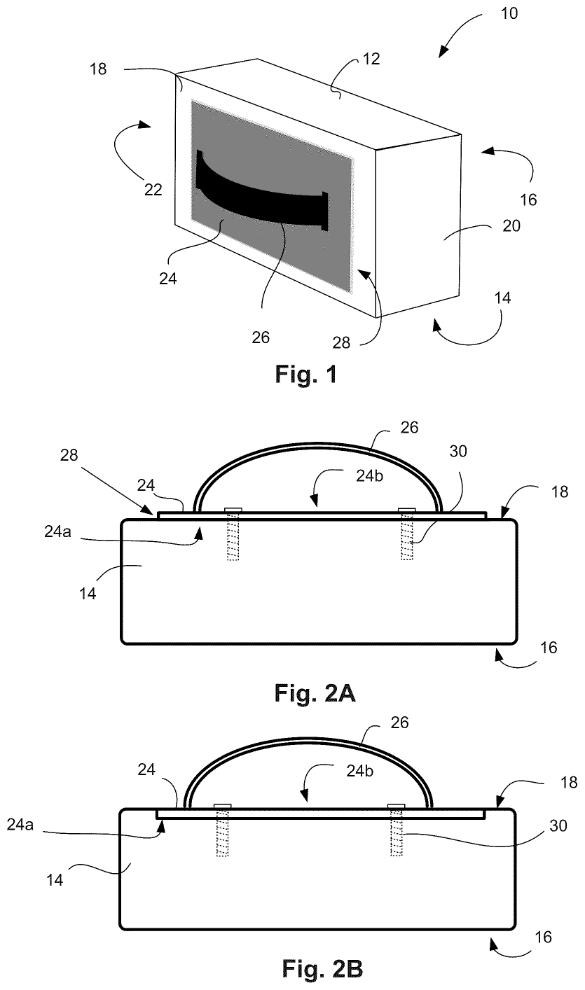

Referring now to FIG. 1, illustrated is an exemplary refractory unit 10 in accordance with an embodiment of the invention. The refractory unit 10 is in the form of a brick, and includes a body formed from a refractory material. The refractory body has an upper main surface 12, a lower main surface 14 opposite the upper main surface 12, an inner surface 16 configurable to face a high temperature chamber (e.g., a container, a conduit or the like), an outer surface 18 opposite the inner surface 16 and configurable to face away from the high temperature chamber, a first side surface 20 and a second side surface 22 opposite the first side surface 20. Arranged on the outer surface 18 is a mount 24, which, in the illustrated embodiment is rectangular in shape, although other shapes are possible. The mount 24 preferably is formed as a plate made preferably of heat resistant material, such as metal or ceramic. The mount also may be formed from a composite material having a combination of metal, ceramic and/or other heat-resistant materials.

With additional reference to FIG. 2A, the mount 24 is mechanically attached to the refractory body and provides a weldable surface for the attachment of an elastic member. More particularly, a first surface 24a of the mount 24 is fixedly attached to the outer surface 18 of the refractory body and an elastic member 26 is connected to a second surface 24b of the mount 24, the second surface opposite and generally parallel to the first surface. The elastic member 26 may be formed integral with the mount 24 (i.e., the elastic member and the mount are formed as a unitary structure), or the elastic member 26 may be attached to the mount 24 using an attachment means, such as a weld or the like.

In the embodiment illustrated in FIG. 1, the mount 24 is attached to the refractory body 10 using a high-temperature adhesive 28 applied to the outer surface 18 of the refractory unit 10 and the first surface 24a of the plate 24. However, other attachment means are possible. For example, in FIG. 2A the mount 24 may be fixed to the refractory body 10 using fasteners 30, such as threaded screws or the like. Such fasteners 30 may be utilized in combination with an adhesive 28 to further strengthen the connection. Alternatively, the mount 24 may be co-molded into the refractory body at the time the refractory body is formed, as shown in FIG. 2B. The mount 24 may include ridges, grooves, apertures, etc. that can receive the refractory material at the time the refractory body is formed, thereby securing the mount 24 into the refractory body. In such embodiment, the exposed second surface 24b of the mount 24 is planar with the outer surface 18. Fasteners 30 also may be used in the embodiment of FIG. 2B to further secure the mount 24 to the refractory body.

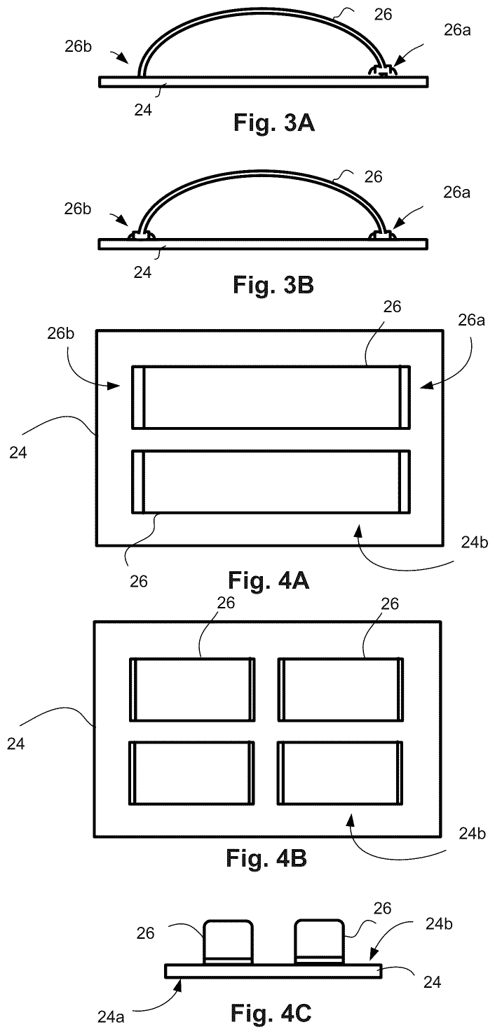

With additional reference to FIGS. 3A-3B, the elastic member 26 is formed as a an elliptical spring (e.g., a leaf spring) having a first end 26a and a second end 26b spaced apart from the first end. In the embodiment of FIG. 3A, the first end 26a is fixedly attached to the mount 24 and the second end 24b is movable relative to the mount. For example, the spring 26 may be a metal spring with the first end 26a welded to the mount 24 and the second end 26b detached from and slidable over the mount 24 (i.e., the second end 26b is free to move relative to the mount 24). In contrast to the embodiment of FIG. 3A, in the embodiment of FIG. 3B both the first end 26a and the second end 26b are fixed to the mount 24.

The refractory unit 10 in accordance with the invention may have one or more elastic members 26. For example, the refractory unit 10 may have a single elastic member 26 as shown in FIG. 1, or may have multiple elastic members 26 as shown in FIGS. 4A-4C. The plural elastic members 26 may be arranged in a series or parallel configuration. FIG. 4A illustrates two elastic members arranged in a parallel configuration, while FIG. 4B illustrates four elastic members arranged in a series and parallel configuration. FIG. 4C illustrates a front view of the embodiments shown in FIGS. 4A and 4B.

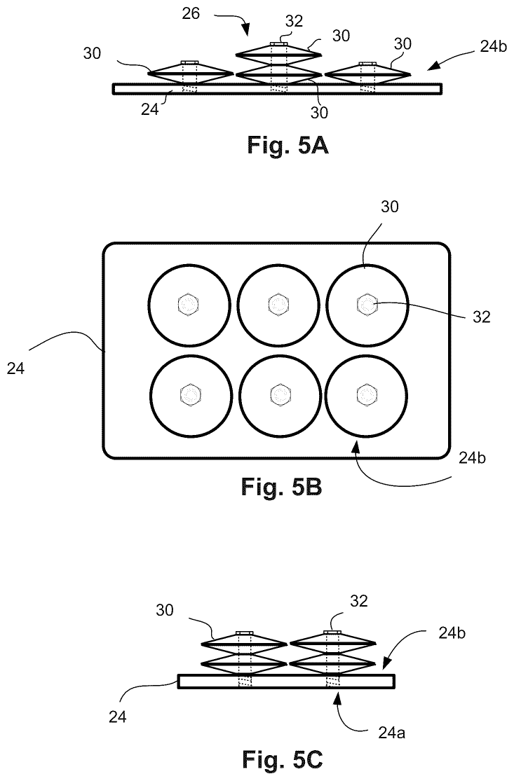

Referring now to FIGS. 5A-5C, illustrated is an elastic member and mount in accordance with another embodiment of the invention. In contrast to the embodiments of FIGS. 1-4C, which utilize an elastic member 26 in the form of an elliptical spring, the embodiment of FIGS. 5A-5C utilize an elastic member 26 in the form of a coned-disc spring. Such elastic member may include a number of springs stacked one over the other, e.g., a plurality of coned-disk springs arranged in a stacked configuration. The coned-disk springs may be attached to the mount 24 and to each other using fasteners 32 and/or an adhesive. As shown in FIGS. 5A-5C, the height of each stack may vary, e.g., the inner portion of the elastic member may be formed from multiple rows of coned-disc springs stacked over each other, and the outer portion may be formed from a single row of coned-disc springs.

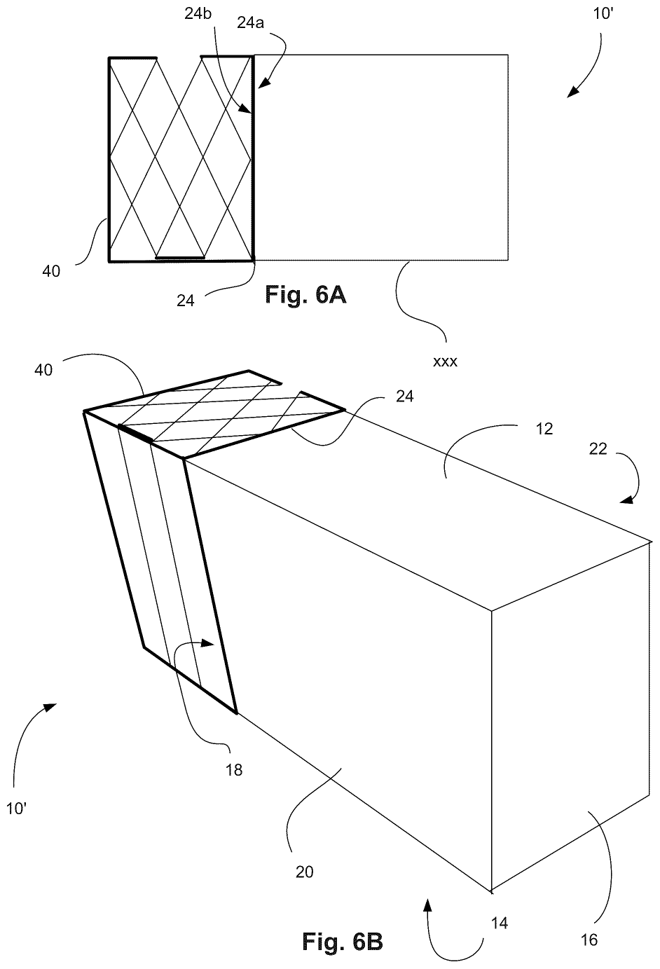

Referring now to FIGS. 6A and 6B, illustrated is yet another embodiment of a refractory unit 10′ in accordance with the invention. The refractory unit 10′ includes a refractory body in the form of a brick having an upper main surface 12, a lower main surface 14 opposite the upper main surface 12, an inner surface 16 configurable to face a high temperature chamber, an outer surface 18 opposite the inner surface 16 and configurable to face away from the high temperature chamber, a first side surface 20 and a second side surface 22 opposite the first side surface 20. Arranged on the outer surface 18 is a mount 24. A first surface 24a of the mount 24 is fixedly attached to the outer surface 18 of the refractory body and an elastic member 40 is connected to a second surface 24b of the mount 24. Attachment of the mount to the refractory body may be as described herein with respect to the embodiments of FIGS. 1-5C (e.g., adhesive, fasteners, embedded within the refractory body, etc.) The elastic member 40 may be formed integral with the mount 24 (i.e., the elastic member and the mount are formed as a unitary structure), or the elastic member 40 may be attached to the mount 24 using an attachment means, such as a weld or the like. In the illustrated embodiment, the elastic member 40 is in the form of a complex spring. The spring may be fabricated from sheet metal formed from high-temperature alloy and may have a linear or wave geometry stacked in series or parallel arrays to provide a desired spring constant.

The refractory unit may further include a combination of dense metallic/RCF composite or RCF composite and an expansion allowance/gasket to create an interior shell against which refractory units can be arranged. The use of an elastic member embedded in a RCF can absorb expansive forces and translate the forces laterally, which can snug the individual insulation packages together.

Accordingly, the refractory units in accordance with the invention enable a refractory lining to be constructed that has elastic properties. These elastic properties of the lining enable lining movement during temperature cycling without subjecting the refractory units to compressive forces or the steel shell to tensile forces. As a result, maintenance costs can be reduced and the useful life of the high temperature process vessel can be extended.

The foregoing description is a specific embodiment of the present invention. It should be appreciated that this embodiment is described for purposes of illustration only, and that numerous alterations and modifications may be practiced by those skilled in the art without departing from the spirit and scope of the invention. It is intended that all such modifications and alterations be included insofar as they come within the scope of the invention as claimed or the equivalents thereof.

1. A refractory unit for lining a high temperature vessel, comprising:
a refractory body formed from a refractory material and having an upper main surface, a lower main surface, an inner surface configurable to face a high temperature chamber, an outer surface configurable to face away from the high temperature chamber, a first side surface and a second side surface; and
an elastic member attached to the outer surface.

2. The refractory unit according to claim 1, further comprising a mount having a first surface and a second surface generally parallel to the first surface, the first surface fixedly attached to the outer surface, and the elastic member attached to the second surface.

3. The refractory unit according to claim 2, wherein the mount comprises at least one of a metal plate, a ceramic plate, or a composite plate.

4. The refractory unit according to claim 2, wherein the mount is molded into the refractory body.

5. The refractory unit according to claim 2, wherein the mount is attached to the refractory body using an adhesive.

6. The refractory unit according to claim 2, wherein the elastic member is welded to the mount.

7. The refractory unit according to claim 1, wherein the elastic member comprises a spring.

8. The refractory unit according to claim 1, wherein the elastic member comprises a leaf spring having a first end and a second end distal from the first end, the first end fixedly attached to the mount and the second end movable relative to the mount.

9. The refractory unit according to claim 1, wherein the elastic member comprises a plurality of elastic members arranged in a series or parallel configuration.

10. The refractory unit according to claim 9, wherein the spring comprises a metal spring.

11. The refractory unit according to claim 9, wherein the spring comprises an array of springs stacked one over the other.

12. The refractory unit according to claim 1, wherein the elastic member comprises at least one coned-disc spring.

13. The refractory unit according to claim 12, wherein the at least one coned-disc spring comprises a plurality of coned-disk springs arranged in a stacked configuration.

14. The refractory unit according to claim 1, wherein the refractory body comprises a preformed refractory shape.

15. The refractory unit according to claim 14, wherein the preformed refractory shape comprises a refractory brick.

16. The refractory unit according to claim 1, wherein the chamber comprises at least one of a container or a conduit.

17. A method for constructing a refractory lining for a high temperature vessel, comprising arranging a plurality of refractory units relative to each other, wherein at least some of the plurality of refractory units are elastically coupled to at least one of an adjacent refractory unit or a shell of the high temperature vessel.

18. The method according to claim 17, wherein each refractory unit comprises a refractory body formed from a refractory material and having an upper main surface, a lower main surface, an inner surface configurable to face a high temperature chamber, an outer surface configurable to face away from the high temperature chamber, a first side surface and a second side surface, the method further comprising arranging a thermal material between the shell and the outer surface of the refractory units.

19. The method according to claim 18, further comprising using the chamber for at least one of metal-making, non-metal making, chemical-making, gas-making, heat-making, or high-temperature reaction.

20. The method according to claim 18, wherein arranging the thermal material comprises using refractory ceramic fiber (RCF) felt as the thermal material.

21. The method according to claim 17, further comprising using an elastic member attached to the plurality of refractory units to provide the elastic coupling.

22. The method according to claim 21, further comprising filling voids between the elastic member and the at least one of the adjacent refractor unit or the steel shell.

23. The method according to claim 22, wherein filling voids comprises using refractory ceramic fiber (RCF) pumpable material or RCF vacuum molding to fill the voids.
